(19) United States
(12) Patent Application Publication
(10) Pub. No.: US 2021/0374107 A1
(43) Pub. Date: Dec. 2, 2021

(54) DISTRIBUTED FILE SYSTEM AND DISTRIBUTED FILE MANAGING METHOD

(71) Applicant: HITACHI, LTD., Tokyo (JP)

(72) Inventors: Yuto KAMO, Tokyo (JP); Masanori TAKATA, Tokyo (JP); Mitsuo HAYASAKA, Tokyo (JP)

(73) Assignee: Hitachi, Ltd.

(21) Appl. No.: 17/008,865

(22) Filed: Sep. 1, 2020

(30) Foreign Application Priority Data
May 26, 2020 (JP) 2020-091286

(51) Int. Cl. G06F 16/182; G06F 16/17; G06F 16/11; G06F 16/16; H04L 29/08

(52) U.S. Cl. CPC G06F 16/1824; G06F 16/1734; H04L 67/06; G06F 16/164; G06F 16/122

(57) ABSTRACT

In a distributed file system, a distributed FS server manages and stores main body data of a file in the distributed FS server or a cloud storage, and stores management information of the main body data, the distributed FS server that received an I/O request from a client specifies the distributed FS server that manages the management information of a target file, and transmits a transfer I/O request for executing I/O processing of the target file, the specified distributed FS server executes processing for the main body data of the target file with respect to the main body data based on the management information corresponding to a target file of the transfer I/O request, and returns a result of the I/O processing to the distributed FS server which is a request source, and the distributed FS server which is the request source returns the returned result to the client.

### BACKGROUND OF THE INVENTION

### 1. Field of the Invention

The present invention relates to a technology for managing files in a distributed manner.

### 2. Description of Related Art

A scale-out type distributed file system is widely used to store a large amount of data used for data analysis and the like. In recent years, a file virtualization function has been provided in a distributed file system for cloud backup, data analysis in the cloud, and data sharing between bases.

In the file virtualization function, it is necessary to manage management information for each file in order to manage an updated region of the file and a region that became a stub. For example, U.S. Pat. No. 9,720,777 describes a technology for storing management information as a data structure separate from a file. In addition, U.S. Pat. No. 9,588,977 describes a technology for storing management information in a file.

For example, when a file is virtualized in a distributed file system, there is a case where a node (I/O receiving node) that has received a user I/O and a node (storage node) that stores management information of a file are different nodes. In this case, when the I/O receiving node executes I/O processing according to the user I/O, in order to acquire the management information from the storage node and update the management information, inter-node communication amount increases, it takes a long time for processing, and there is a concern that latency of the user I/O deteriorates.

In a distributed file system that manages files by dividing the files into predetermined units (chunks), when replicating (transferring) file data to a cloud storage, the node that controls the file transfer performs processing of acquiring the chunk data from the node that stores each chunk configuring the file and transferring the acquired data to the cloud storage, but even in this case, the inter-node communication amount increases and there is a problem that it takes a long time for processing.

### SUMMARY OF THE INVENTION

The present invention has been made in view of the above-described circumstances, and an object thereof is to provide a technology capable of reducing inter-node communication in a distributed file system.

In order to achieve the above-described object, there is provided a distributed file system including: a plurality of distributed file servers that manage files by distributing the files into units; and a storage node that is capable of storing at least a part of main body data of the files to be managed by the plurality of distributed file servers, in which the distributed file server manages and stores the main body data of a file to be managed in the distributed file server itself or the storage node, and stores management information for managing a state of the main body data for each office in the distributed file server itself, a first distributed file server that has received an I/O request of a file from a host apparatus specifies a second distributed file server that manages the management information of a target file of the I/O request, and transmits a transfer I/O request for executing I/O processing of the target file of the I/O request to the second distributed file server, the second distributed file server is configured to execute the I/O processing for the main body data of the target file with respect to the main body data stored in the second distributed file server or the storage node based on the management information corresponding to a target file of the transfer I/O request, and return a processing result of the I/O processing to the first distributed file server, and the first distributed file server returns the processing result to the host apparatus.

According to the present invention, inter-node communication can be reduced in a distributed file system.

### BRIEF DESCRIPTION OF THE DRAWINGS

FIG. 1 is a diagram illustrating a processing outline of a distributed file system according to a first embodiment;

FIG. 2 is an overall configuration diagram of the distributed file system according to the first embodiment;

FIG. 3 is a configuration diagram of a distributed FS server according to the first embodiment;

FIG. 4 is a configuration diagram of an object storage according to the first embodiment;

FIG. 5 is a configuration diagram of a main body file and a management information file according to the first embodiment;

FIG. 6 is a diagram describing an overview of file distribution according to the first embodiment;

FIG. 7 is a flowchart of file creation processing according to the first embodiment;

FIG. 8 is a flowchart of user I/O transfer processing according to the first embodiment;

FIG. 9 is a flowchart of a file write processing according to the first embodiment;

FIG. 10 is a flowchart of file read processing according to the first embodiment;

FIG. 11 is a diagram illustrating a processing outline of a distributed file system according to a second embodiment;

FIG. 12 is a diagram describing an overview of file distribution according to the second embodiment;

FIG. 13 is a flowchart of file replication processing (first time) according to the second embodiment; and

FIG. 14 is a flowchart of the file replication processing (difference reflection) according to the second embodiment.

### DESCRIPTION OF EMBODIMENTS

Embodiments will be described with reference to the drawings. In addition, the embodiments described below do not limit the invention according to the claims, and it is not necessary that all of the elements and combinations described in the embodiments are essential to the solution means of the invention.

In the following description, there are cases where the processing is described using “program” as an acting subject, but as the program is executed by a processor, the specified processing is appropriately performed using at least one of a storage unit and an interface unit, and thus, the acting subject of the processing may be a processor (or a computer or a computing system having a processor). The program may be installed in the computer from a program source. The program source may be, for example, a program distribution server or a storage medium readable by the computer. In addition, in the following description, two or more programs may be realized as one program, or one program may be realized as two or more programs. Further, at least apart of the processing realized by executing the program may be realized by a hardware circuit (for example, an application specific integrated circuit (ASIC) or a field-programmable gate array (FPGA)).

First, a processing outline of a distributed file system according to a first embodiment will be described.

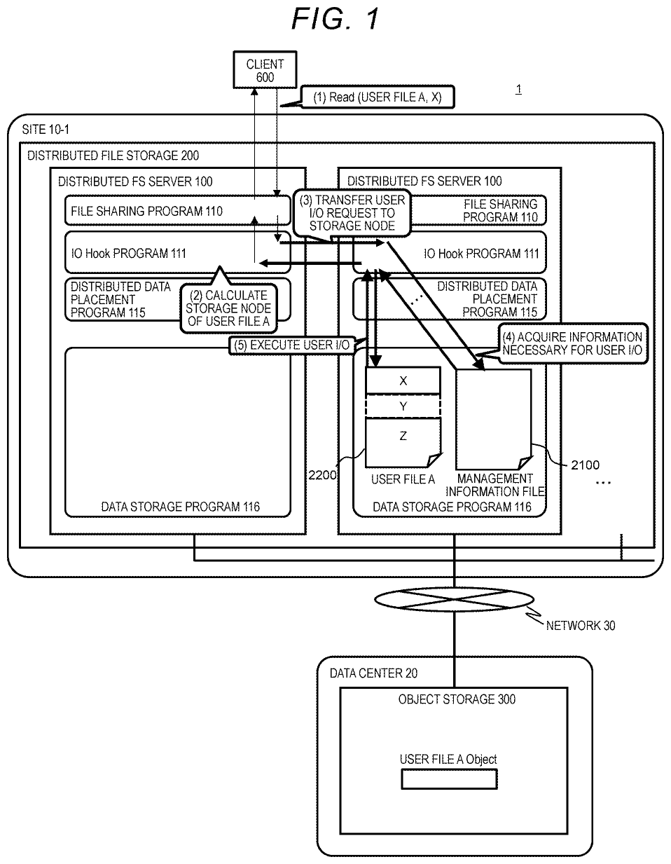

FIG. 1 is a diagram illustrating a processing outline of the distributed file system according to the first embodiment.

In a distributed file system 1, when an I/O request (user I/O request: here, a read request) is issued from a client 600 by a user (FIG. 1(1)), a file sharing program 110 of any distributed FS (file system) server 100 (receiving node) in a distributed file storage 200 receives the user I/O request. Here, the read request includes information (for example, a user file name) for identifying the file to be read, an offset and a data length of a region (target region) to be read in a user file.

An IO Hook program 111 recognizes that the file sharing program 110 has received the user I/O request, and calculates and specifies the distributed FS server 100 (storage node) that stores a target file of the user I/O request (FIG. 1(2)).

Next, the IO Hook program 111 transfers the user I/O request to the specified storage node (FIG. 1(3)).

When receiving the transmitted user I/O request, the IO Hook program 111 of the storage node acquires a management information file 2100 corresponding to the target file of the user I/O request via a distributed data placement program 115 and a data storage program 116 (FIG. 1(4)).

Next, the IO Hook program 111 refers to the acquired management information file 2100 to execute user I/O processing (here, read processing) for a target region of the file corresponding to the user I/O request (FIG. 1(5)). Here, the data in the storage node is acquired from storage media of the storage node, and the data which is not in the storage node is acquired from an object storage 300 via a network 30. Accordingly, the IO Hook program 111 can acquire the data of the target region of the file.

Next, the IO Hook program 111 performs a response (here, the data of the read target region is included) to the user I/O request with respect to the receiving node which is a transfer source of the user I/O request. Next, the IO Hook program 111 of the receiving node passes the response to the file sharing program 110. Next, the file sharing program 110 returns a response to the client 600 which is an issue source of the user I/O request.

In this manner, according to the distributed file system of the present embodiment, the receiving node that has received the user I/O request transfers the user I/O request to the storage node and does not execute the I/O processing, and thus, inter-node communication is not performed in order to receive the management information file 2100 of the file and perform processing of reading the target region of the file, the inter-node communication amount can be reduced, and as a result, it is possible to improve latency with respect to the user I/O request.

Next, the configuration of the distributed file system 1 will be described.

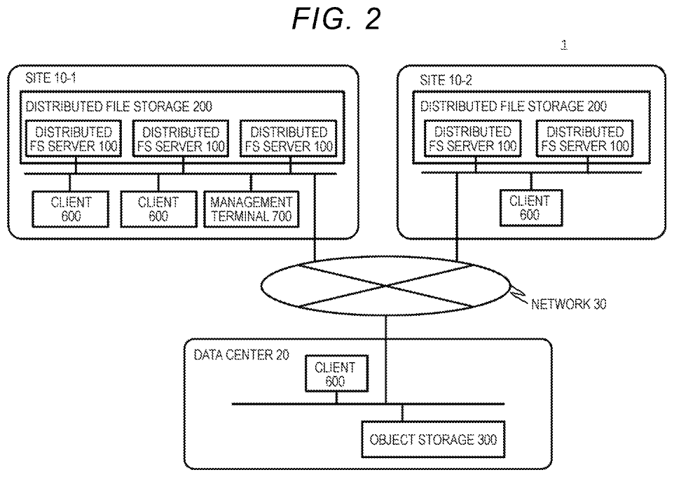

FIG. 2 is an overall configuration diagram of the distributed file system according to the first embodiment.

The distributed file system 1 includes the plurality of distributed FS servers 100, one or more object storages 300, one or more clients 600, and one or more management terminals 700. The distributed FS server 100, the object storage 300, the client 600, and the management terminal 700 are connected to each other via the network 30. The network 30 is, for example, a wired local area network (LAN), a wireless LAN, or a wide area network (WAN).

The respective components of the distributed file system 1 are arranged in either of the sites (also referred to as edges) 10-1 and 10-2 and a data center 20 (also referred to as cloud).

In the site 10-1, the plurality of distributed FS servers 100, one or more clients 600, and the management terminal 700 are included. The plurality of distributed FS servers 100, one or more clients 600, and the management terminal 700 are connected to each other, for example, via the LAN. The plurality of distributed FS servers 100 may be connected to each other by a dedicated network (backend network). The distributed file storage 200 is configured of the plurality of distributed FS servers 100. The distributed file storage 200 manages files in a distributed manner. The client 600 is an example of a host apparatus, and is configured of, for example, a personal computer (PC) including a processor, a memory, and the like. The client 600 executes various types of processing, reads files related to the processing from the distributed file storage 200, and stores the read files in the distributed file storage 200. The management terminal 700 performs setting of the distributed file storage 200 and the like.

In the site 10-2, the plurality of distributed FS servers 100 and one or more clients 600 are included. The distributed file storage 200 is configured of the plurality of distributed FS servers 100.

The data center 20 includes the object storage 300, which is an example of a storage node, and the client 600. The object storage 300 stores and manages data in object units. Instead of the object storage 300, a file storage that stores and manages data in a file format may be used. Further, the data center 20 may include a management terminal.

Next, the configuration of the distributed FS server 100 will be described.

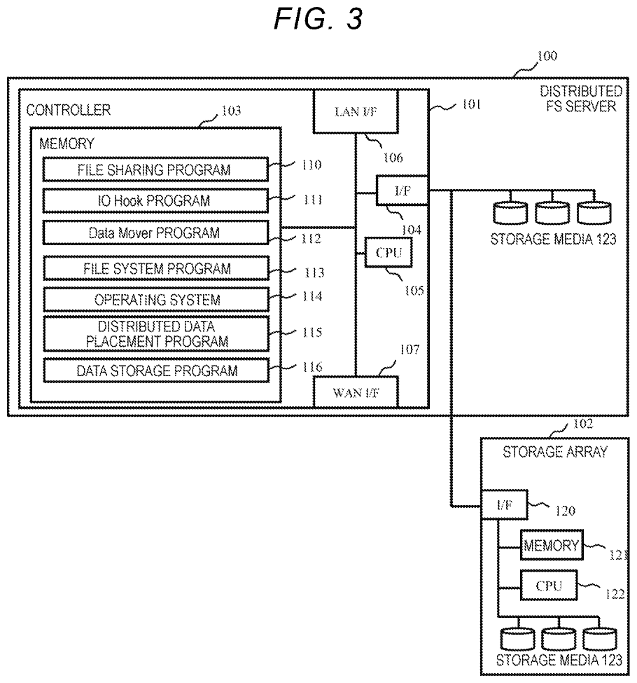

FIG. 3 is a configuration diagram of the distributed FS server according to the first embodiment.

The distributed FS server 100 is an example of a distributed file server, and includes a controller 101 and one or more storage media 123.

The storage medium 123 is an example of a storage device, is a device capable of storing data, such as a hard disk drive (HDD) and a solid state drive (SSD), and stores a program executed by the CPU 105, data used by the CPU 105, a file used in the client 600, file management information of the file, and the like.

The controller 101 includes a memory 103, an I/F 104, a CPU 105 as an example of a processor, a LAN interface (I/F) 106, and a WAN interface (I/F) 107.

The memory 103 stores various programs executed by the CPU 105 and information. The memory 103 stores the file sharing program 110, the IO Hook program 111, a Data Mover program 112, a file system program 113, an operating system 114, the distributed data placement program 115, and the data storage program 116.

The file sharing program 110 is executed by the CPU 105 to perform processing of sharing the storage media of a plurality of apparatuses (for example, the distributed FS storage 100) on the network.

The IO Hook program 111 is executed by the CPU 105 to detect that the file sharing program 110 has received the user I/O request, specify the distributed FS server 100 that manages the file corresponding to the user I/O request as a storage node in accordance with the user I/O request, and perform processing of transferring the user I/O request to the storage node. Further, the IO Hook program 111 records a log regarding the user I/O request received by the file sharing program 110.

The Data Mover program 112 is executed by the CPU 105 to asynchronously reflect the newly created or updated file in the object storage 300 of the data center 20. Further, the Data Mover program 112 is executed by the CPU 105 to stub files having low access frequency when the storage capacity on the edge side is tight. The file system program 113 is executed by the CPU 105 to perform processing of managing data as a file.

The operating system 114 is executed by the CPU 105 to perform processing of managing and controlling the entire distributed FS server 100. The distributed data placement program 115 is executed by the CPU 105 to perform processing of disposing and managing file data in a distributed manner. The data storage program 116 is executed by the CPU 105 to perform processing of storing and managing data in the storage medium 123.

The I/F 104 mediates communication with the storage medium 123 and a storage array 102. The CPU 105 executes various types of processing by executing the programs stored in the memory 103. The LAN I/F 106 mediates communication with other apparatuses via the LAN. The WAN I/F 107 mediates communication with other apparatuses via the WAN.

The storage array 102 may be connected to the distributed FS server 100. The storage array 102 includes an interface (I/F) 120, a memory 121, a CPU 122, and one or more storage media 123. The I/F 120 mediates the notification with the controller 101. The memory 121 stores a program for the CPU 122 to execute input/output processing (I/O processing) with respect to the storage medium 123, and information. The CPU 122 executes the program stored in the memory 121 to execute the I/O processing with respect to the storage medium 123. According to the storage array 102, the controller 101 can execute the I/O processing with respect to the storage medium 123 of the storage array 102.

In addition, the distributed FS server 100 may be configured of a bare metal server (physical server), a virtual computer (VM), or a so-called container.

Next, the configuration of the object storage 300 will be described.

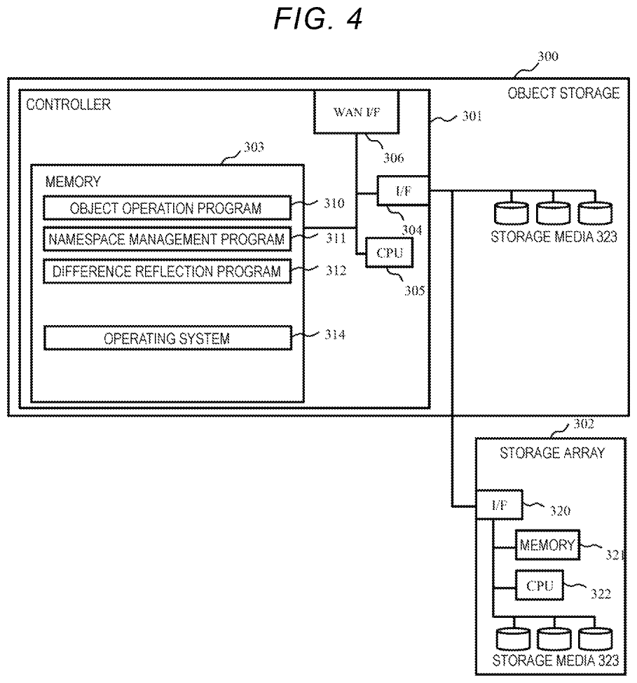

FIG. 4 is a configuration diagram of the object storage according to the first embodiment.

The object storage 300 is a storage that stores and manages data as an object, and includes a controller 301 and one or more storage media 323. In addition, the object storage 300 may distribute and dispose the data.

The storage medium 323 is an example of a storage device, is a device capable of storing data, such as a hard disk drive (HDD) and a solid state drive (SSD), and stores a program executed by a CPU 305, data used by the CPU 305, an object, the management information of the object, and the like.

The controller 301 includes a memory 303, an I/F 304, a CPU 305 as an example of a processor, and a WAN interface (I/F) 306.

The memory 303 stores various programs executed by the CPU 305 and information. The memory 303 stores an object operation program 310, a name space management program 311, a difference reflection program 312, and an operating system 314.

The object operation program 310 is executed by the CPU 305 to perform operation processing of an object stored in the storage medium 323. The name space management program 311 is executed by the CPU 305 to perform processing of managing a name space. The difference reflection program 312 is executed by the CPU 305 to perform processing of reflecting a difference on an object. The operating system 314 is executed by the CPU 305 to perform processing of managing and controlling the entire object storage 300.

The I/F 304 mediates communication with the storage medium 323 and a storage array 302. The CPU 305 executes various types of processing by executing the programs stored in the memory 303. The WAN I/F 306 mediates communication with other apparatuses via the WAN.

The storage array 302 may be connected to the object storage 300. The storage array 302 includes an interface (I/F) 320, a memory 321, a CPU 322, and one or more storage media 323. The I/F 320 mediates the notification with the controller 301. The memory 321 stores a program for the CPU 322 to execute input/output processing (I/O processing) with respect to the storage medium 323, and information. The CPU 322 executes the program stored in the memory 321 to execute the I/O processing with respect to the storage medium 323. According to the storage array 302, the controller 301 can execute the I/O processing with respect to the storage medium 323 of the storage array 302.

Next, in the distributed file storage 200, the configuration of a file (main body file) that stores user data (main body data) and a file (management information file: management information file) that stores management information for managing the main body file will be described.

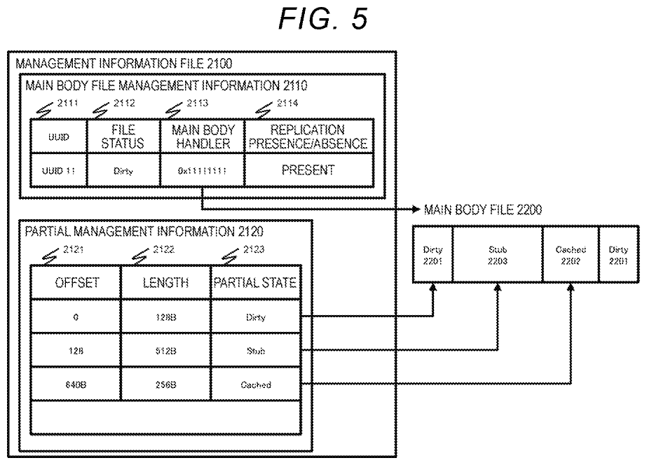

FIG. 5 is a configuration diagram of the main body file and the management information file according to the first embodiment.

In the present embodiment, the management information file 2100 and a main body file 2200 are stored in the storage medium 123 in the same distributed FS server 100.

The management information file 2100 is an example of management information, and includes main body file management information 2110 and partial management information 2120.

The main body file management information 2110 is information for managing the main body file 2200, and includes fields of a UUID 2111, a file status 2112, a main body handler 2113, and replication presence/absence 2114.

In the UUID 2111, an identifier (UUID: universally unique identifier) for uniquely identifying the main body file 2200 on the object storage 300 is stored. In the file status 2112, the file status of the main body file 2200 is stored. As the file status, there are Dirty which is a state where the main body file 2200 includes data that is not reflected on the object storage 300, Stub which is a state where the entire main body file became a stub, and Cached which is a state where the entire data of the main body file 2200 is reflected on the object storage 300 and is stored in the distributed FS server 100. The main body handler 2113 is a value that uniquely identifies the main body file 2200 and can be used for designating the main body file 2200 in a system call as an operation target. The replication presence/absence 2114 stores whether or not the data of the main body file 2200 has been replicated to the object storage 300.

The partial management information 2120 includes an entry for managing the state of each of one or more parts of the main body file 2200. The entry of the partial management information 2120 includes fields of an offset 2121, a length 2122, and a partial state 2123.

The offset 2121 stores the offset (position from the head of the file) of the part corresponding to the entry. In the length 2122, the length (data length) of the part corresponding to the entry is stored. In the partial state 2123, the state of the part corresponding to the entry is stored. As the state of the part, there are Dirty which is a state where the partial data is not reflected on the object storage 300, Stub which is a state where the partial data became a stub, and Cached which is a state where the partial data is reflected on the object storage 300 and is stored in the distributed FS server 100.

The main body file 2200 is a file that includes one or more parts configuring the user data, and each part is in one of the states of Dirty 2201, Stub 2203, and Cached 2202. The Dirty 2201 is a state where the partial data thereof is not reflected on the object storage 300. The Stub 2203 is a state where the partial data thereof became a stub. The Cached 2202 is a state where the partial data thereof is reflected on the object storage 300 and is stored in the distributed FS server 100.

Next, an outline of file distribution in the distributed file storage 200 will be described.

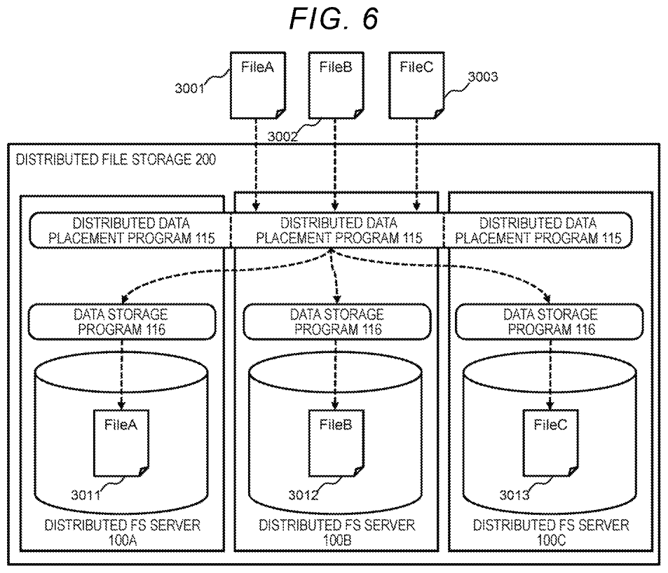

FIG. 6 is a diagram describing an overview of the file distribution according to the first embodiment.

In the distributed file storage 200 according to the present embodiment, the files are distributed and arranged in the plurality of distributed FS servers 100 into units of files. For example, for a file 3001 (File A), the managed distributed FS server 100A is determined by the distributed data placement program 115, and the file is managed as a file 3011 in the distributed FS server 100A by the data storage program 116. Similarly, a file 3002 (File B) is managed as a file 3012 in a distributed FS server 100B, and a file 3003 (File C) is managed as a file 3013 in a distributed FS server 100C.

Next, file creation processing in the distributed file system 1 will be described.

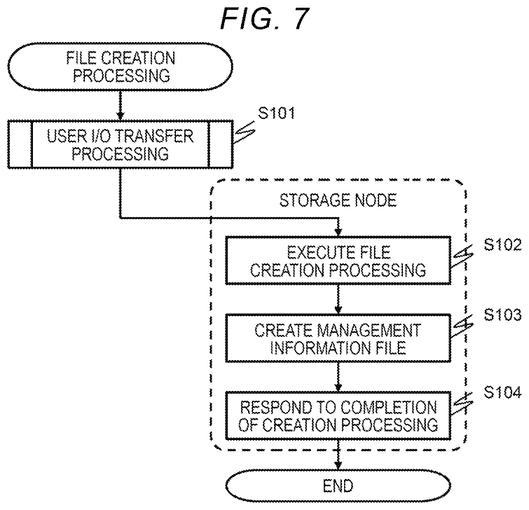

FIG. 7 is a flowchart of the file creation processing according to the first embodiment.

The file creation processing is executed when any of the distributed FS servers 100 receives a creation request (file creation request) for a file from the client 600.

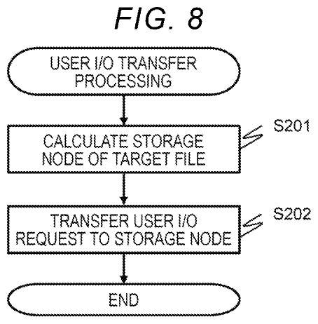

The distributed FS server 100 (receiving node) that has received the file creation request executes user I/O transfer processing (refer to FIG. 8) (step S101). Accordingly, the file creation request is transmitted to the distributed FS server 100 (storage node) which is in charge of managing (storing) the file corresponding to the file creation request.

When receiving the file creation request, the storage node executes the file creation processing (step S102). Specifically, the storage node determines the distributed FS server 100 that creates a file specified in the file creation request based on the file name. In the present embodiment, a hash value for a file name is calculated, and the distributed FS server 100 is determined based on the hash value. Here, even when determining the distributed FS server 100 to which the file creation request is transferred, the determination is made by the same processing, and thus, the distributed FS server 100 itself that executes this processing is determined. Next, the distributed FS server 100 creates a main body file that stores the user data in its own storage medium 123.

Next, the storage node creates a file (management information file) that stores management information corresponding to the main body file (step S103). Specifically, the storage node determines the distributed FS server 100 that creates the management information file 2100 based on a management information file name. In the present embodiment, the management information file 2100 is set to the management information file name including the file name of the main body file 2200, calculates the hash value using the file name of the main body file 2200 having the management information file name with respect to the management information file 2200, and determines the distributed FS server 100 based on this hash value. For example, the management information file name may be “.“file name of main body file”.mnr”, and the file name of the main body file may be extracted from the management information file name. As a result, the distributed FS server 100 which is the same as the distributed FS server 100 that stores the main body file 2200 is determined as the distributed FS server 100 that creates the management information file 2100. In other words, the distributed FS server 100 itself that executes this processing is determined. Next, the distributed FS server 100 creates the management information file 2100 in its own storage medium 123.

Next, the storage node responds to the completion of the file creation processing with respect to the receiving node (step S104). After this, the receiving node will transmit a response to the file creation request to the client 600 which is a request source.

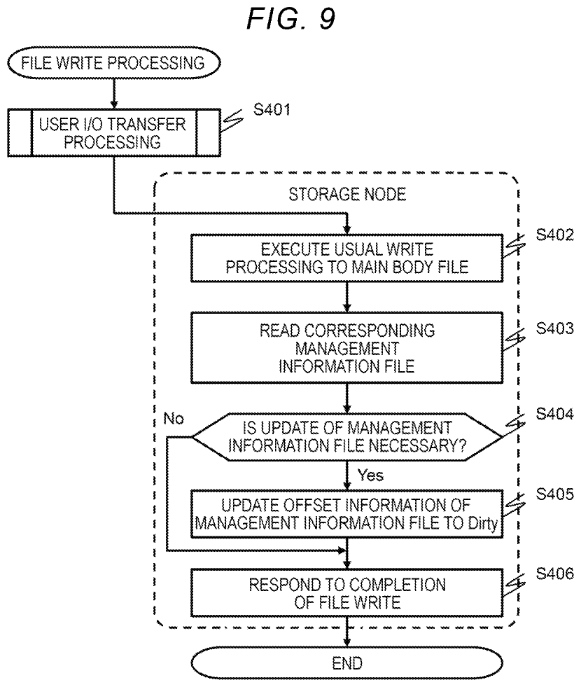

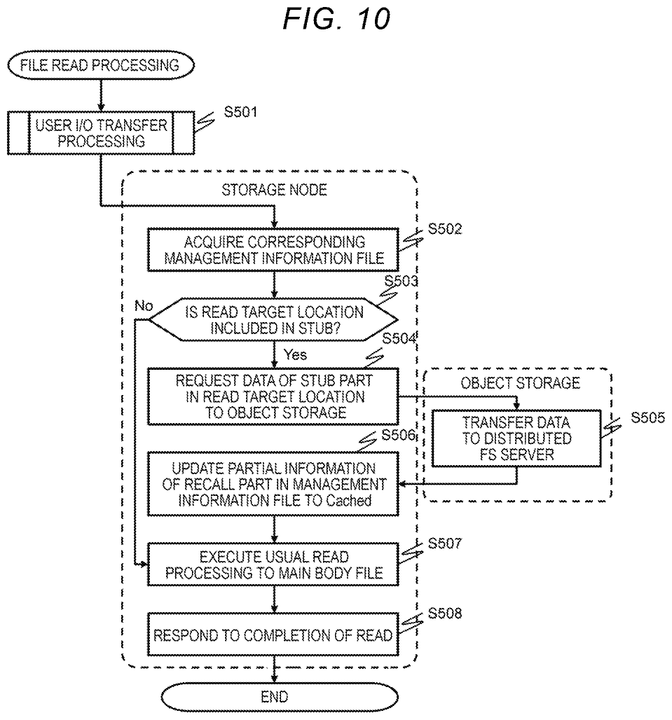

Next, the user I/O transfer processing (step S101 in FIG. 7, step S401 in FIG. 9, and step S501 in FIG. 10) by the receiving node will be described.

FIG. 8 is a flowchart of the user I/O transfer processing according to the first embodiment.

The receiving node calculates and specifies the distributed FS server 100 (storage node) of the access destination (storage destination) of the target file in the user I/O request (file creation request in step S101 of FIG. 7) (step S201). In the present embodiment, the storage node is specified based on the hash value of the file name of the target file.

Next, the receiving node transfers the user I/O request to the storage node (step S202) and ends the processing. Here, in the present embodiment, the user I/O request is a request for the storage node to execute the I/O processing included in the received user I/O request.

Next, file write processing in the distributed file system 1 will be described.

FIG. 9 is a flowchart of the file write processing according to the first embodiment.

The file write processing is executed when any of the distributed FS servers 100 receives a write request for a file from the client 600.

The distributed FS server 100 (receiving node: an example of the first storage node) that has received the write request executes the user I/O transfer processing (refer to FIG. 8) (step S401). Accordingly, the write request is transmitted to the distributed FS server 100 (storage node: an example of the second storage node) that stores the file corresponding to the write request.

When receiving the write request, the storage node executes the write processing (step S402). Specifically, the storage node determines the distributed FS server 100 that stores the file specified in the write request based on the file name. In the present embodiment, a hash value for a file name is calculated, and the distributed FS server 100 is determined based on the hash value. Here, even when determining the distributed FS server 100 to which the write request is transferred, the determination is made by the same processing, and thus, the distributed FS server 100 itself that executes this processing is determined. Next, the distributed FS server 100 stores the target user data of the write request in the main body file.

Next, the storage node reads a file (management information file 2100) that stores the management information corresponding to the main body file (step S403). Here, the storage node specifies the distributed FS server 100 that stores the management information file 2100 based on the management information file name corresponding to the file name of the main body file. In the present embodiment, the management information file is set to the management information file name including the file name of the main body file 2200, calculates the hash value using the file name of the main body file having the management information file name with respect to the management information file 2100, and specifies the distributed FS server 100 based on this hash value. As a result, the distributed FS server 100 which is the same as the distributed FS server 100 that stores the main body file is specified as the distributed FS server 100 that stores the management information file 2100. In other words, the distributed FS server 100 itself that executes this processing is specified as the distributed FS server 100 that stores the management information file 2100. Next, the storage node reads the management information file 2100 from the specified distributed FS server 100, that is, its own storage medium 123.

Next, the storage node determines whether or not the management information file 2100 needs to be updated (step S404). Specifically, the storage node determines whether or not the state of the part (region) of the file to be written is Dirty, determines that the update is not necessary when the state of the part of the file to be written is Dirty, and determines that the update is necessary, when the state is a state other than Dirty.

As a result, when it is determined that the update of the management information file 2100 is not necessary (step S404: No), the storage node advances the processing to step S406. Meanwhile, when it is determined that the update of the management information file 2100 is necessary (step S404: Yes), the storage node updates the partial state 2123 to Dirty in the entry of the partial management information 2120 corresponding to the offset of the part of the file to be written, sets the file status 2112 of the main body file management information 2110 (step S405) to Dirty, and advances the processing to step S406.

In step S406, the storage node transmits a response (completion response) indicating that the writing of the file has been completed, to the receiving node. Then, the storage node ends the processing. In addition, when receiving the completion response, the receiving node returns the response to the write request to the client 600 that has performed the write request.

According to the above-described file write processing, when reading or updating the management information file 2100, communication (inter-node communication) with the other distributed FS servers 100 may not occur, and the processing efficiency related to the write request is improved. Accordingly, the latency for the write request of the client 600 is improved.

Next, file read processing in the distributed file system 1 will be described.

FIG. 10 is a flowchart of file read processing according to the first embodiment.

The file read processing is executed when any of the distributed FS servers 100 receives a read request (I/O request) for a file from the client 600.

The distributed FS server 100 (receiving node) that has received the read request executes the user I/O transfer processing (refer to FIG. 8) (step S501). Accordingly, the read request is transmitted to the distributed FS server 100 (storage node) that stores the file corresponding to the read request.

When receiving the read request, the storage node reads the management information file 2100 corresponding to the target main body file of the read request (step S502). Specifically, first, the storage node specifies the distributed FS server 100 that stores the management information file 2100 based on the management information file name corresponding to the file name of the main body file. In the present embodiment, the management information file 2100 is set to the management information file name including the file name of the main body file 2200, calculates the hash value using the file name of the main body file having the management information file name with respect to the management information file 2100, and specifies the distributed FS server 100 based on this hash value. Here, even when determining the distributed FS server 100 to which the read request is transferred, the determination is made by the same processing, and thus, the distributed FS server 100 itself that executes this processing is determined. Next, the storage node reads the management information file 2100 of the read request target file from its own storage medium 123.

Next, the storage node determines, based on the management information file 2100, whether or not the target location of the read request includes a part in the stub state (step S503).

As a result, when it is determined that the target location of the read request does not include the part in the stub state (step S503: No), it is indicated that all the data is stored in the storage medium 123 of the own node, and thus, the storage node advances the processing to step S507.

Meanwhile, when it is determined that the target location of the read request includes the part in the stub state (step S503: Yes), the data at the part in the stub state needs to be acquired from the object storage 300, and thus, the storage node requests the object storage 300 for the data at the part in the stub state (step S504).

The object storage 300 that has received the request for the data at the part in the stub state, reads the requested data from the storage medium 323, and transfers the read data to the storage node (step S505).

When receiving the data at the part in the stub state from the object storage 300, the storage node updates the value of the partial state 2123 of the entry corresponding to the part received in the management information file 2100 to Cached (step S506), and advances the processing to step S507.

In step S507, the storage node executes the read processing of reading the corresponding data from the main body file 2200 which is the target of the read request, and advances the processing to step S508.

In step S508, the storage node transmits a response (completion response) indicating that the reading of the file has been completed, to the receiving node. Then, the storage node ends the processing. In addition, when receiving the completion response, the receiving node returns a response to the read request to the client 600 that has performed the read request.

According to the above-described file read processing, in the storage node, the communication (inter-node communication) with the other distributed FS servers 100 may not occur when reading or updating the management information file 2100, and the communication with the other distributed FS servers 100 may not occur when reading the data of the main body file 2200. Accordingly, the efficiency of the read processing is improved, and the latency for the read request of the client 600 is improved.

Next, a distributed file system according to a second embodiment will be described. Here, since the distributed file system according to the second embodiment has many parts in common with the distributed file system according to the first embodiment, for convenience, the same reference numerals as those of each component in the distributed file system according to the first embodiment will be used, and the description will be made focusing on differences.

The distributed file system according to the second embodiment manages the main body file that manages the user data by distributing the main body file into predetermined units (chunk units).

First, a processing outline of the distributed file system according to the second embodiment will be described.

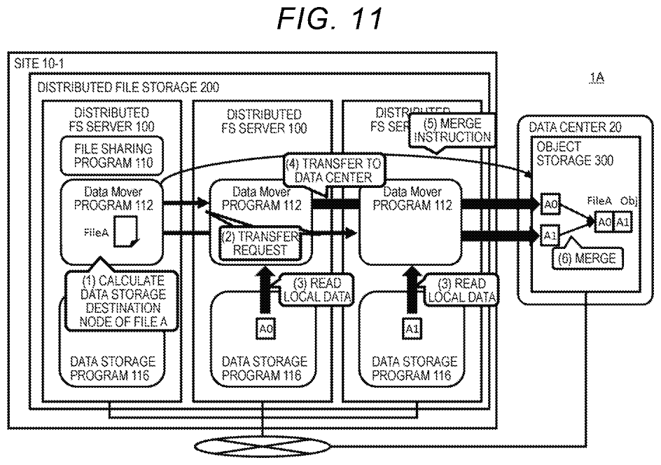

FIG. 11 is a diagram illustrating a processing outline of the distributed file system according to the second embodiment.

In a distributed file system 1A, when a certain main body file (File A in this example) of the distributed file storage 200 is moved (replicated) to the object storage 300 for the first time, the Data Mover program 112 of the certain distributed FS server 100 is specified by calculating one or more distributed FS servers 100 (storage nodes) that store files to be replicated (FIG. 11(1)).

Next, the Data Mover program 112 transmits the request (transfer request) for transferring the chunks of the files to the object storage 300, to each of the one or more distributed FS servers 100 that store the respective chunks of the files (target files) to be replicated (FIG. 11(2)).

In each distributed FS server 100 that has received the transfer request, the Data Mover program 112 reads the chunk data of the target file of the transfer request from the storage medium 123 of the distributed FS server 100 to which the data itself belongs (FIG. 11(3)), and transfers the read data to the object storage 300 of the data center 20 (FIG. 11(4)). In addition, when the read data is transferred, the Data Mover program 112 returns a response indicating that the transfer is performed with respect to the distributed FS server 100 which is the request source of the transfer request.

When a response that the transfer from all of the distributed FS servers 100 that have performed the request is performed has been received, the distributed FS server 100 which is the request source of the transfer request transmits the instruction (merge instruction) for merging (coupling) the data of all chunks corresponding to the main body file with respect to the object storage 300 of the data center 20 (FIG. 11(5)).

The object storage 300 that has received the merge instruction merges the data of all the chunks of the main body file which is the target of the merge instruction (FIG. 11(6)).

Next, an outline of file distribution in the distributed file storage 200 will be described.

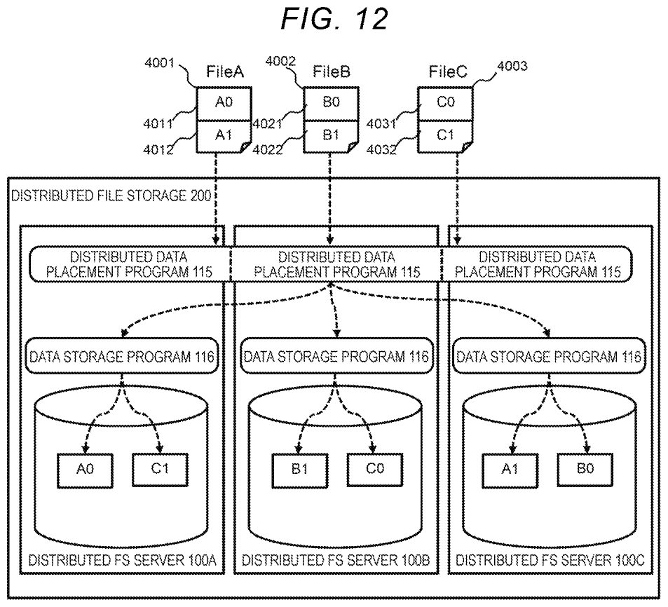

FIG. 12 is a diagram describing an overview of the file distribution according to the second embodiment.

In the distributed file storage 200 according to the present embodiment, the files are distributed and arranged in the plurality of distributed FS servers 100 into units of chunks. For example, regarding a file 4001 (File A), the distributed FS server 100A that manages a chunk 4011 (chunk A0) and the distributed FS server 100C that manages a chunk 4012 (chunk A1) are determined by the distributed data placement program 115, and the chunks A0 and A1 are stored in each of the distributed FS servers 100A and 100C by the data storage program 116 of each of the distributed FS servers 100A and 100C. Similarly, regarding a file 4002 (File B), chunks 4021 (chunk B0) and 4022 (chunk B1) are stored in each of the distributed FS servers 100C and 100B, and regarding a file 4003 (File C), chunks 4031 (chunk C0) and 4032 (chunk C1) are stored in each of the distributed FS servers 100A and 100B.

In the present embodiment, the distributed data placement program 115 may store the main body file management information 2110 in the management information file 2100 in all distributed FS servers 100 that store each chunk, or in a predetermined region determined in advance in the distributed file storage 200, for example, in the region of a pool for storing the metadata of the file system. Meanwhile, regarding the partial management information 2120 of the management information file 2100, the information of the entry corresponding to each chunk may be stored in the distributed FS server 100 that stores each chunk. In addition, the information of the entry corresponding to each chunk may be stored as the extended attribute of the chunk.

Next, file replication processing (first time) will be described.

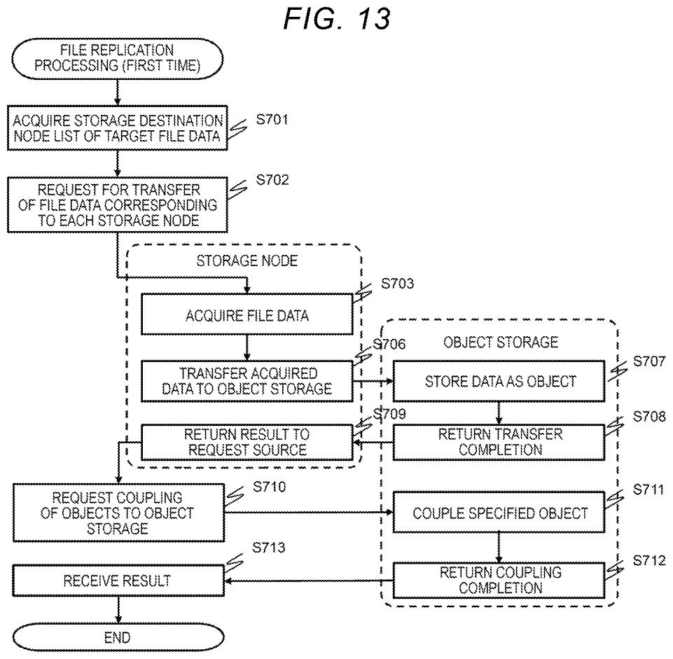

FIG. 13 is a flowchart of the file replication processing (first time) according to the second embodiment.

The file replication processing (first time) is processing executed when the IO Hook program 111 of the predetermined distributed FS server 100 specifies a written file with reference to a log of the user I/O request received by the file sharing program 110 at a predetermined time, and detects that the value of the replication presence/absence 2114 of the main body file management information 2110 of the management information file 2100 corresponding to this file is “absent”, that is, the corresponding main body file still has not been replicated in the object storage 300.

The distributed FS server 100 (detection node: an example of a first storage node) that specifies the written file with reference to the log of the user I/O request received by the file sharing program 110, and detects that the value of the replication presence/absence 2114 of the main body file management information 2110 of the management information file 2100 corresponding to the file is “absent” acquires a list (storage node list) of the distributed FS server 100 (storage node: an example of a second storage node) that stores the data of each chunk in a specified file (referred to as target file in the description of this processing) (step S701). Here, the storage node list can be acquired from, for example, the file placement information in which each chunk configuring each file and the identification information of the distributed FS server 100 (node) that stores each chunk are associated with each other. In addition, the file placement information may be stored in each distributed FS server 100 or may be stored in a predetermined storage region. Further, the file placement information may be obtained by calculation from the file name and the size.

Next, the detection node transmits a request (transfer request) for transferring the chunk data of the target file stored in each storage node to the object storage 300, to each storage node in the storage node list (step S702).

Each storage node that has received the transfer request acquires the chunk data of the target file specified in the transfer request from its own storage medium 123 (step S703). Next, the storage node transmits the acquired chunk data of the target file to the object storage 300 (step S706).

The object storage 300 stores the chunk data of the target file transmitted from the storage node as an object in the storage medium 323 (step S707), and transmits a notification (completion notification) of completion of storage to the storage node (step S708). Here, the completion notification includes, for example, identification information (UUID) of the object corresponding to the chunk data.

When receiving the completion notification from the object storage 300, the storage node returns the transfer result to the detection node which is a request source of the transfer request (step S709). The transfer result includes, for example, the identification information of the target chunk and the identification information of the object in which the chunk is stored.

In the detection node, when receiving the transfer results of the transfer requests of all the chunks of the target file, a coupling request for coupling the objects corresponding to each chunk included in the transfer result is transmitted to the object storage 300 (step S710). This coupling request includes, for example, identification information of the objects to be coupled.

The object storage 300 generates an object obtained by coupling the objects corresponding to the coupling request, that is, an object corresponding to the data of the main body file, and stores the generated object in the storage medium 323 (step S711). Then, the object storage 300 returns the coupling completion indicating that the coupling is completed to the detection node (step S712). In the combination completion, the identification information of the objects obtained by coupling is included.

The detection node receives the coupling completion, associates the identification information of the object included in the coupling completion with the main body file (step S713), and ends the processing.

According to the above-described file replication processing (first time), communication of chunk data may not occur between the detection node and the storage node, and the processing efficiency is improved.

Next, file replication processing (difference reflection) will be described.

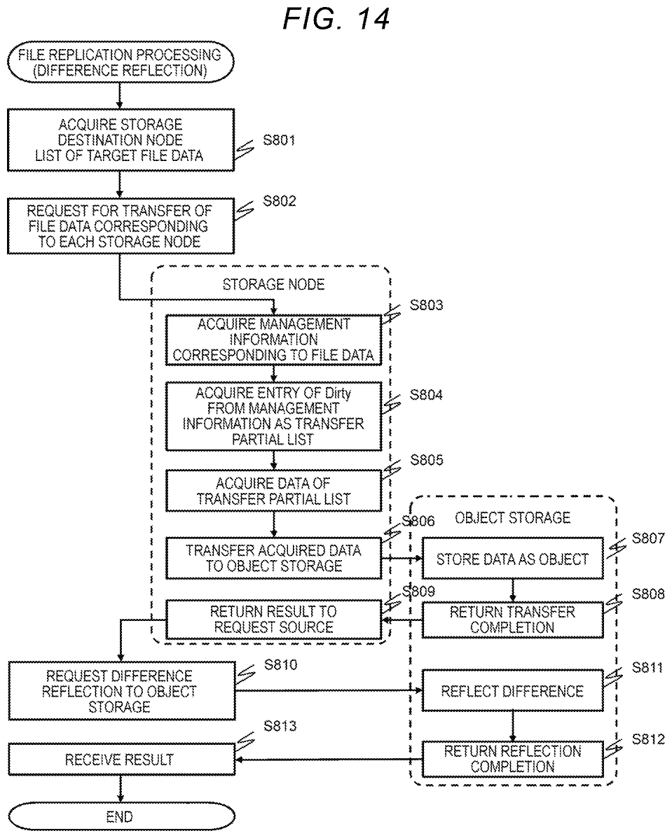

FIG. 14 is a flowchart of the file replication processing (difference reflection) according to the second embodiment.

The file replication processing (difference reflection) is processing executed when the IO Hook program 111 of the predetermined distributed FS server 100 specifies a written file with reference to a log of the user I/O request received by the file sharing program 110 at a predetermined time, and detects that the value of the replication presence/absence 2114 of the main body file management information 2110 of the management information file 2100 corresponding to this file is “present”, that is, the corresponding main body file is replicated in the object storage 300.

The distributed FS server 100 (detection node) that specifies the written file with reference to the log of the user I/O request received by the file sharing program 110, and detects that the value of the replication presence/absence 2114 of the main body file management information 2110 of the management information file 2100 corresponding to the file is “present” acquires a list (storage node list) of the distributed FS server 100 (storage node) that stores the data of each chunk in a specified file (referred to as target file in the description of this processing) (step S801). Here, the storage node list can be acquired from, for example, the file placement information in which each chunk configuring each file and the identification information of the distributed FS server (node) that stores each chunk are associated with each other.

Next, the detection node transmits a request (transfer request) for transferring the updated chunk data of the target file stored in each storage node to the object storage 300, to each storage node in the storage node list (step S802).

When receiving the transfer request, each storage node reads the partial management information 2200 of the chunk stored therein, which corresponds to the target file of the transfer request (step S803). Here, since the partial management information 2200 of the chunk stored in the storage node itself is stored in the storage medium 123 of the storage node itself, the storage node reads the partial management information 2200 of the chunk from the storage medium 123.

The storage node refers to the acquired partial management information 2200 to acquire an entry in which the partial state 2123 is Dirty as a transfer partial list from the entries corresponding to the chunks of the file which is the target of the transfer request (step S804).

Next, the storage node acquires the chunk data corresponding to each entry of the transfer part list from the storage medium 123 (step S805), and transfers the acquired chunk data to the object storage 300 (step S806).

The object storage 300 stores the chunk data of the target file transmitted from the storage node as an object in the storage medium 323 (step S807), and transmits a notification (completion notification) indicating that the storage is completed to the storage node (step S808). Here, the completion notification includes, for example, identification information (UUID) of the object corresponding to the chunk data.

When receiving the completion notification from the object storage 300, the storage node returns the transfer result to the detection node which is a request source of the transfer request (step S809). The transfer result includes, for example, the offset of the target chunk and the identification information of the object in which the chunk is stored.

In the detection node, when receiving the transfer result from the storage node that has issued the transfer request, a difference reflection request for reflecting the object corresponding to the chunk included in the transfer result on the object of the main body file is transmitted to the object storage 300 (step S810). Here, the difference reflection request includes, for example, the offset in the main body file of the chunk and the identification information of the chunk object.

When receiving the difference reflection request, the object storage 300 reflects the data of the chunk object included in the difference reflection request to the object of the main body file according to the offset of the difference reflection request (step S811). Then, the object storage 300 returns the reflection completion indicating that the difference reflection is completed to the detection node (step S812).

The detection node receives the reflection completion (step S813) and ends the processing.

According to the above-described file replication processing (difference reflection), communication of chunk data may not occur between the detection node and the storage node, and the processing efficiency is improved.

In addition, the present invention is not limited to the above-described embodiments, and can be appropriately modified and carried out without departing from the spirit of the present invention.

For example, in the above-described embodiments, an example in which the user data and the management information for managing the user data are described as separate files has been illustrated, but the present invention is not limited thereto, and for example, the management information may be included in a region (for example, extended region) which is a part of a file that stores the user data.

Further, in the above-described embodiments, a part or all of the processing performed by the CPU may be performed by a hardware circuit. In addition, the program in the above-described embodiments may be installed from a program source. The program source may be a program distribution server or a storage medium (for example, a portable storage medium).

What is claimed is:

1. A distributed file system comprising:
a plurality of distributed file servers that manage files by distributing the files into units; and
a storage node that is capable of storing at least a part of main body data of the files to be managed by the plurality of distributed file servers, wherein
the distributed file server manages and stores the main body data of a file to be managed in the distributed file server itself or the storage node, and stores management information for managing a state of the main body data for each offset in the distributed file server itself,
a first distributed file server that has received an I/O request of a file from a host apparatus specifies a second distributed file server that manages the management information of a target file of the I/O request, and transmits a transfer I/O request for executing I/O processing of the target file of the I/O request to the second distributed file server,
the second distributed file server is configured to
execute the I/O processing for the main body data of the target file with respect to the main body data stored in the second distributed file server or the storage node based on the management information corresponding to a target file of the transfer I/O request, and
return a processing result of the I/O processing to the first distributed file server, and
the first distributed file server returns the processing result to the host apparatus.

2. The distributed file system according to claim 1, wherein the management information is stored in the file of the main body data.

3. The distributed file system according to claim 1, wherein the management information is stored in a management information file different from the file of the main body data.

4. The distributed file system according to claim 3, wherein
a management information file name, which is a file name of the management information file, includes a file name of the file of the main body data, and
the first distributed file server specifies a distributed file server that manages the file of the main body data according to a hash value based on the file name of the file of the main body data, and determines a distributed file server that manages the management information file according to the hash value based on the file name of the main body data included in the destination information file name.

5. A distributed file system comprising:
a plurality of distributed file servers that manage the files by dividing the files into units of chunks; and
a storage node that is capable of storing at least a part of main body data of the files to be managed by the plurality of distributed file servers, wherein
placement information indicating the distributed file server that manages the chunks of the files is stored in a predetermined storage apparatus,
the distributed file server manages and stores the main body data of the chunk of the file to be managed in the distributed file server itself or the storage node, and stores management information for managing a state of the main body data for each offset in the distributed file server itself,
when transferring a predetermined file to the storage node, a first distributed file server specifies one or more second distributed file servers that manage the management information of each chunk of a file to be transferred based on the placement information, and transmits a transfer request for executing transfer processing of the chunk of the file to be transferred to the storage node, to the one or more second distributed file servers,
one or more second distributed file servers are configured to
read the main body data of the chunk of the target file from the second distributed file server based on the management information corresponding to the chunk of the target file of the transfer request, and
transfer the read main body data of the chunk to the storage node,
the first distributed file server transmits a coupling request for coupling the main body data of each chunk transferred from the one or more second distributed file servers to the storage node, to the storage node, and
when receiving the coupling request, the storage node stores a file obtained by coupling the main body data of each chunk transmitted from the one or more second distributed file servers in a host storage apparatus.

6. The distributed file system according to claim 5, wherein
the first distributed file server specifies one or more second distributed file servers that manage each chunk of the file to be transferred based on the placement information when transferring a difference of a predetermined file to the storage node, and transmits the transfer request for executing transfer processing of the difference of the chunk of the file to be transferred to the storage node, to the one or more second distributed file servers,
the one or more second distributed file servers are configured to
read main body data of the difference of the chunk of the target file from the second distributed file server based on the management information corresponding to the difference of the chunk of the target file of the transfer request, and
transfer the read main body data of the difference of the chunk to the storage node,
the first distributed file server transmits a reflection request for reflecting the main body data of the difference of each chunk transferred from the one or more second distributed file servers to the storage node, to the storage node, and
when receiving the reflection request, the storage node reflects the difference of each chunk transmitted from one or more second distributed file servers on the file.

7. The distributed file system according to claim 5, wherein the management information is stored in the file of the main body data of the chunk.

8. The distributed file system according to claim 5, wherein
the predetermined storage apparatus is a storage apparatus of each distributed file server that manages the chunk of the file, or a storage apparatus that manages metadata of a file system that manages the file.

9. A distributed file managing method executed by a distributed file system including a plurality of distributed file servers that manage files by distributing the files into units, and a storage node that is capable of storing at least a part of main body data of the files to be managed by the plurality of distributed file servers, wherein
the distributed file server manages and stores the main body data of a file to be managed in the distributed file server itself or a file server, and stores management information for managing a state of the main body data for each offset in the distributed file server itself,
a first distributed file server that has received an I/O request of a file from a host apparatus specifies a second distributed file server that manages the management information of a target file of the I/O request, and transmits a transfer I/O request for executing I/O processing of the target file of the I/O request to the second distributed file server,
the second distributed file server that has received the transfer I/O request is configured to
execute the I/O processing for the main body data of the target file with respect to the main body data stored in the second distributed file server or the storage node based on the management information corresponding to a target file of the transfer I/O request, and
return a processing result of the I/O processing to the first distributed file server, and
the first distributed file server returns the returned processing result to the host apparatus.

10. A distributed file managing method executed by a distributed file system including a plurality of distributed file servers that manage the files by dividing the files into units of chunks, and a storage node that is capable of storing at least a part of main body data of the files to be managed by the plurality of distributed file servers, wherein
the distributed file system stores placement information indicating the distributed file server that manages the chunks of the files in a predetermined storage apparatus,
the distributed file server manages and stores the main body data of the chunk of the file to be managed in the distributed file server itself or the storage node, and stores management information for managing a state of the main body data for each offset in the distributed file server itself,
when transferring a predetermined file to the storage node, a first distributed file server specifies one or more second distributed file servers that manage each chunk of a file to be transferred based on the placement information, and transmits a transfer request for executing transfer processing of the chunk of the file to be transferred to the storage node, to the one or more second distributed file servers,
one or more second distributed file servers are configured to
read the main body data of the chunk of the target file from the second distributed file server based on the management information corresponding to the chunk of the target file of the transfer request, and
transfer the read main body data of the chunk to the storage node,
the first distributed file server transmits a coupling request for coupling the main body data of each chunk transferred from the one or more second distributed file servers to the storage node, to the storage node, and
when receiving the coupling request, the storage node stores a file obtained by coupling the main body data of each chunk transmitted from the one or more second distributed file servers in a host storage apparatus.
